(19) United States
(12) Patent Application Publication
(10) Pub. No.: US 2021/0383256 A1
(43) Pub. Date: Dec. 9, 2021

(54) SYSTEM AND METHOD FOR ANALYZING CROWDSOURCED INPUT INFORMATION

(71) Applicant: INTELLI NETWORK CORPORATION, Calgary (CA)

(72) Inventor: Kamea Aloha LAFONTAINE, Calgary (CA)

(21) Appl. No.: 17/288,512

(22) PCT Filed: Oct. 31, 2019
(86) PCT No.: PCT/IB2019/059356

§ 371 Date: Apr. 23, 2021

Related U.S. Application Data
(60) Provisional application No. 62/754,061, filed on Nov. 1, 2018.

(51) Int. Cl. G06N 5/04; G06N 20/00

(52) U.S. Cl. CPC G06N 5/04; G06N 3/04; G06N 20/00

(57) ABSTRACT

A system and method for analyzing input crowdsourced information, preferably according to an AI (artificial intelligence) model. The AI model may include machine learning and/or deep learning algorithms. The crowdsourced information may be obtained in any suitable manner, including but not limited to written text, such as a document, or audio information. The audio information is preferably converted to text before analysis.

### FIELD OF THE INVENTION

The present invention provides a system and method for analyzing crowdsourced input information, and in particular, to such a system and method for analyzing input crowdsourced information, preferably according to an AI (artificial intelligence) model.

### BACKGROUND OF THE INVENTION

Analysis of crowdsourced information is a difficult problem to solve. Currently such analysis largely relies on manual labor to review the crowdsourced information. This is clearly impractical as a large scale solution.

For example, for reporting crimes and tips related to crimes, crowdsourced information can be very valuable. But simply gathering large amounts of tips is not useful, as the information is of widely varying quality and may include errors or biased information, which further reduces its utility. Currently the police need to review crime tips manually, which requires many person hours and makes it more difficult to fully use all received information.

### BRIEF SUMMARY OF THE INVENTION

The present invention, in at least some embodiments, relates to a system and method for analyzing input crowdsourced information, preferably according to an AI (artificial intelligence) model. The AI model may include machine learning and/or deep learning algorithms. The crowdsource information may be obtained in any suitable manner, including but not limited to written text, such as a document, or audio information. The audio information is preferably converted to text before analysis.

By “document”, it is meant any text featuring a plurality of words. The algorithms described herein may be generalized beyond human language texts to any material that is susceptible to tokenization, such that the material may be decomposed to a plurality of features.

The crowdsourced information may be any type of information that can be gathered from a plurality of user-based sources. By “user-based sources” it is meant information that is provided by individuals. Such information may be based upon sensor data, data gathered from automated measurement devices and the like, but is preferably then provided by individual users of an app or other software as described herein.

Preferably the crowdsourced information includes information that relates to a person, that impinges upon an individual or a property of that individual, or that is specifically directed toward a person. Non-limiting examples of such crowdsourced types of information include crime tips, medical diagnostics, valuation of personal property (such as a house) and evaluation of candidates for a job or for a placement at a university.

Preferably the process for evaluating the information includes removing any emotional content or bias from the crowdsourced information. For example, crime relates to people personally—whether to their body or their property. Therefore, crime tips impinge directly on people's sense of themselves and their personal space. Desensationalizing this information is preferred to prevent errors of judgement. For these types of information, removing any emotionally laden content is important to at least reduce bias.

Preferably, the evaluation process also includes determining a gradient of severity of the information, and specifically of the situation that is reported with the information. For example and without limitation, for crime, there is typically an unspoken threshold, gradient or severity in a community that determines when a crime would be reported. For a crime that is not considered to be sufficiently serious to call the police, the app or other software for crowdsourcing the information may be used to obtain the crime tip, thereby providing more intelligence about crime than would otherwise be available.

Such crowdsourcing may be used to find the small, early beginnings of crime and map the trends and reports for the community.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Unless otherwise defined, all technical and scientific terms used herein have the same meaning as commonly understood by one of ordinary skill in the art to which this invention belongs. The materials, methods, and examples provided herein are illustrative only and not intended to be limiting.

An algorithm as described herein may refer to any series of functions, steps, one or more methods or one or more processes, for example for performing data analysis.

Implementation of the apparatuses, devices, methods and systems of the present disclosure involve performing or completing certain selected tasks or steps manually, automatically, or a combination thereof. Specifically, several selected steps can be implemented by hardware or by software on an operating system, of a firmware, and/or a combination thereof. For example, as hardware, selected steps of at least some embodiments of the disclosure can be implemented as a chip or circuit (e.g., ASIC). As software, selected steps of at least some embodiments of the disclosure can be implemented as a number of software instructions being executed by a computer (e.g., a processor of the computer) using an operating system. In any case, selected steps of methods of at least some embodiments of the disclosure can be described as being performed by a processor, such as a computing platform for executing a plurality of instructions.

Software (e.g., an application, computer instructions) which is configured to perform (or cause to be performed) certain functionality may also be referred to as a “module” for performing that functionality, and also may be referred to a “processor” for performing such functionality. Thus, processor, according to some embodiments, may be a hardware component, or, according to some embodiments, a software component.

Further to this end, in some embodiments: a processor may also be referred to as a module; in some embodiments, a processor may comprise one or more modules; in some embodiments, a module may comprise computer instructions—which can be a set of instructions, an application, software—which are operable on a computational device (e.g., a processor) to cause the computational device to conduct and/or achieve one or more specific functionality. Some embodiments are described with regard to a “computer,” a “computer network,” and/or a “computer operational on a computer network.” It is noted that any device featuring a processor (which may be referred to as “data processor”; “pre-processor” may also be referred to as “processor”) and the ability to execute one or more instructions may be described as a computer, a computational device, and a processor (e.g., see above), including but not limited to a personal computer (PC), a server, a cellular telephone, an IP telephone, a smart phone, a PDA (personal digital assistant), a thin client, a mobile communication device, a smart watch, head mounted display or other wearable that is able to communicate externally, a virtual or cloud based processor, a pager, and/or a similar device. Two or more of such devices in communication with each other may be a “computer network.”

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the drawings:

FIG. 1 shows an exemplary illustrative non-limiting schematic block diagram of a system for processing incoming information by using various types of artificial intelligence (AI) techniques including but not limited to machine learning and deep learning;

FIG. 2 shows a non-limiting exemplary method for analyzing received information from a plurality of users through a crowdsourcing model of receiving user information in a method that preferably also relates to artificial intelligence;

FIGS. 3A and 3B relate to non-limiting exemplary systems and flows for providing information to an artificial intelligence system with specific models employed and then analyzing it;

FIG. 4 relates to a non-limiting exemplary flow for analyzing information by an artificial intelligence engine as described herein;

FIG. 5 relates to a non-limiting exemplary flow for training the AI engine as described herein;

FIG. 6 relates to a non-limiting exemplary method for obtaining training data for training the neural net models as described herein;

FIG. 7 relates to a non-limiting exemplary method for evaluating a source for data for training and analysis as described herein;

FIG. 8 relates to a non-limiting exemplary method for performing context evaluation for data;

FIG. 9 relates to a non-limiting exemplary method for connection evaluation for data;

FIG. 10 relates to a non-limiting exemplary method for source reliability evaluation;

FIG. 11 relates to a non-limiting exemplary method for a data challenge process; and

FIG. 12 relates to a non-limiting exemplary method for a reporting assistance process.

### DESCRIPTION OF AT LEAST SOME EMBODIMENTS

The present invention, in at least some embodiments, relates to a system and method for analyzing input crowdsourced information, preferably according to an AI (artificial intelligence) model. The AI model may include machine learning and/or deep learning algorithms. The crowdsource information may be obtained in any suitable manner, including but not limited to written text, such as a document, or audio information. The audio information is preferably converted to text before analysis.

By “document”, it is meant any text featuring a plurality of words. The algorithms described herein may be generalized beyond human language texts to any material that is susceptible to tokenization, such that the material may be decomposed to a plurality of features.

Various methods are known in the art for tokenization. For example and without limitation, a method for tokenization is described in Laboreiro, G. et al (2010, Tokenizing micro-blogging messages using a text classification approach, in ‘Proceedings of the fourth workshop on Analytics for noisy unstructured text data’, ACM, pp. 81-88).

Once the document has been broken down into tokens, optionally less relevant or noisy data is removed, for example to remove punctuation and stop words. A non-limiting method to remove such noise from tokenized text data is described in Heidarian (2011, Multi-clustering users in twitter dataset, in ‘International Conference on Software Technology and Engineering, 3 rd (ICSTE 2011)’, ASME Press). Stemming may also be applied to the tokenized material, to further reduce the dimensionality of the document, as described for example in Porter (1980, ‘An algorithm for suffix stripping’, Program: electronic library and information systems 14(3), 130-137).

The tokens may then be fed to an algorithm for natural language processing (NLP) as described in greater detail below. The tokens may be analyzed for parts of speech and/or for other features which can assist in analysis and interpretation of the meaning of the tokens, as is known in the art.

Alternatively or additionally, the tokens may be sorted into vectors. One method for assembling such vectors is through the Vector Space Model (VSM). Various vector libraries may be used to support various types of vector assembly methods, for example according to OpenGL. The VSM method results in a set of vectors on which addition and scalar multiplication can be applied, as described by Salton & Buckley (1988, ‘Term-weighting approaches in automatic text retrieval’, Information processing & management 24(5), 513-523).

To overcome a bias that may occur with longer documents, in which terms may appear with greater frequency due to length of the document rather than due to relevance, optionally the vectors are adjusted according to document length. Various non-limiting methods for adjusting the vectors may be applied, such as various types of normalizations, including but not limited to Euclidean normalization (Das et al., 2009, ‘Anonymizing edge-weighted social network graphs’, Computer Science, UC Santa Barbara, Tech. Rep. CS-2009-03); or the TF-IDF Ranking algorithm (Wu et al, 2010, Automatic generation of personalized annotation tags for twitter users, in ‘Human Language Technologies: The 2010 Annual Conference of the North American Chapter of the Association for Computational Linguistics’, Association for Computational Linguistics, pp. 689-692).

One non-limiting example of a specialized NLP algorithm is word2vec, which produces vectors of words from text, known as word embeddings. Word2vec has a disadvantage in that transfer learning is not operative for this algorithm. Rather, the algorithm needs to be trained specifically on the lexicon (group of vocabulary words) that will be needed to analyze the documents.

Optionally the tokens may correspond directly to data components, for use in data analysis as described in greater detail below. The tokens may also be combined to form one or more data components, for example according to the type of information requested. For example, for crime tip or report, a plurality of tokens may be combined to form a data component related to the location of the crime. Preferably such a determination of a direct correspondence or of the need to combine tokens for a data component is determined according to natural language processing.

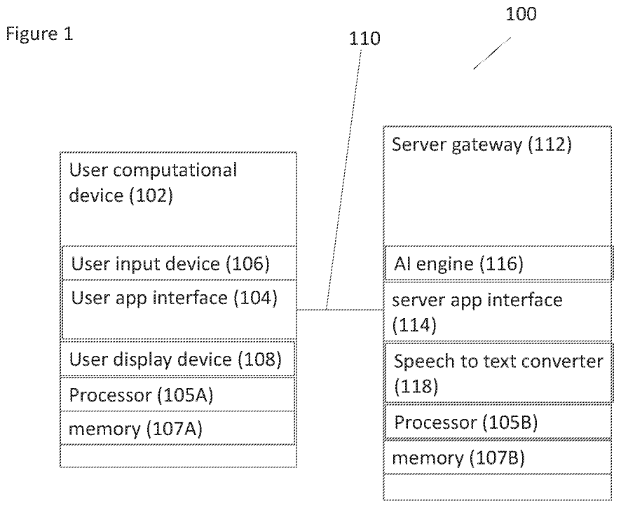

Turning now to the figures, FIG. 1 shows an exemplary illustrative non-limiting schematic block diagram of a system for processing incoming information by using various types of artificial intelligence (AI) techniques including but not limited to machine learning and deep learning. As shown in the system 100, there is provided a user computational device 102 in communication with the server gateway 112 through a computer network 110 such as the internet for example.

User computational device 102 includes the user input device 106, the user app interface 104, and user display device 108. The user input device 106 may optionally be any type of suitable input device including but not limited to a keyboard, microphone, mouse, or other pointing device and the like. Preferably user input device 106 includes a list, a microphone and a keyboard, mouse, or keyboard mouse combination.

User display device 108 is able to display information to the user for example from user app interface 104. The user operates user app interface 104 to intake information for review by an artificial intelligence engine being operated by server gateway 112. This information is taken in from user app interface 104 through the server app interface 114 and may optionally also include a speech to text converter 118 for converting speech to text. The information analyze range in 116 preferably takes the form of text and may actually take the form of crime tips or tips about a reported or viewed crime.

Preferably AI engine 116 receives a plurality of different tips or other types of information from different users operating different user computational devices 102. In this case, preferably user app device 104 and or user computational device 102 is identified in such a way so as to be able to sort out duplicate tips or reported information, for example by identifying the device itself or by identifying the user through user app interface 104.

User computational device 102 also comprises a processor 105A and a memory 107A. Functions of processor 105A preferably relate to those performed by any suitable computational processor, which generally refers to a device or combination of devices having circuitry used for implementing the communication and/or logic functions of a particular system. For example, a processor may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processor may further include functionality to operate one or more software programs based on computer-executable program code thereof, which may be stored in a memory, such as a memory 107A in this non-limiting example. As the phrase is used herein, the processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Also optionally, memory 107A is configured for storing a defined native instruction set of codes. Processor 105A is configured to perform a defined set of basic operations in response to receiving a corresponding basic instruction selected from the defined native instruction set of codes stored in memory 107A. For example and without limitation, memory 107A may store a first set of machine codes selected from the native instruction set for receiving information from the user through user app interface 104 and a second set of machine codes selected from the native instruction set for transmitting such information to server 106 as crowdsourced information.

Similarly, server 106 preferably comprises a processor 105B and a memory 107B with related or at least similar functions, including without limitation functions of server 106 as described herein. For example and without limitation, memory 107B may store a first set of machine codes selected from the native instruction set for receiving crowdsourced information from user computational device 102, and a second set of machine codes selected from the native instruction set for executing functions of AI engine 116.

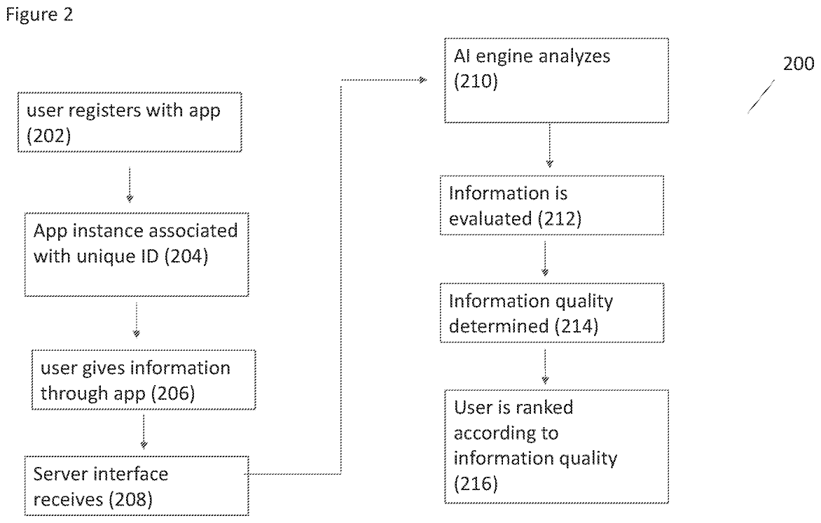

FIG. 2 shows a non-limiting exemplary method for analyzing received information from a plurality of users through a crowdsourcing model of receiving user information in a method that preferably also relates to artificial intelligence. As shown in the method 200, first the user registers with the app in 202. Next, the app instance is associated with a unique ID in 204. This unique ID may be determined according to the specific user, but is preferably also associated with the app instance. Preferably the app is downloaded and operated on a user mobile device as a user computational device, in which case the unique identifier may also be related to the mobile device.

Next, the user gives information through the app in 206, which is received by the server interface at 208. The AI engine analyzes the information in 210 and then evaluates it in 212. After the evaluation, preferably the information quality is determined in 214. The user is then ranked according to information quality in 216. Such a ranking preferably involves comparing information from a plurality of different users and assessing the quality of the information provided by the particular user in regard to the information provided by all users. For example, preferably the process described with regard to FIG. 2 is performed for information received from a plurality of different users, so that the relative quality of the information provided by the users may be determined through ranking. Determining such a relative quality of provided information then enables the users to be ranked according to information quality, which may for example relate to a user reputation ranking (described in greater detail below).

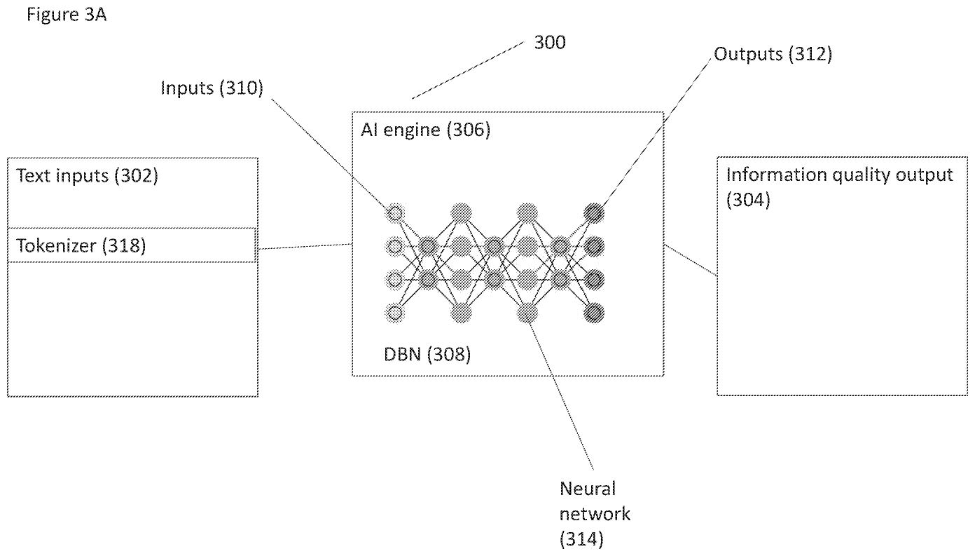

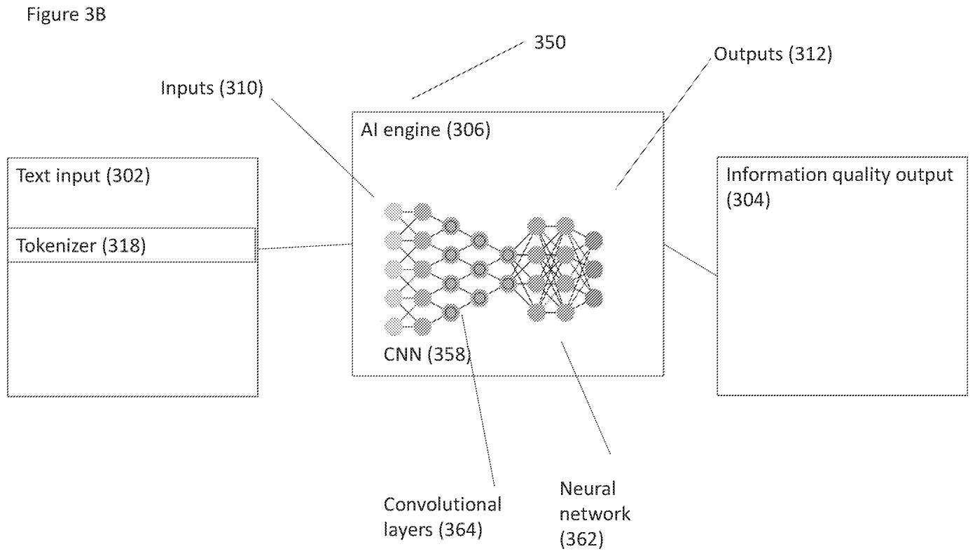

FIGS. 3A and 3B relate to non-limiting exemplary systems and flows for providing information to an artificial intelligence system with specific models employed and then analyzing it. Turning now to FIG. 3A as shown in a system 300, text inputs are preferably provided at 302 and preferably are also analyzed with the tokenizer in 318. A tokenizer is able to break down the text inputs into parts of speech. It is preferably also able to stem the words. For example, running and runs could both be stemmed to the word run. This tokenizer information is then fed into an AI engine in 306 and information quality output is provided by the AI engine in 304. In this non-limiting example, AI engine 306 comprises a DBN (deep belief network) 308. DBN 308 features input neurons 310 and neural network 314 and then outputs 312.

A DBN is a type of neural network composed of multiple layers of latent variables (“hidden units”), with connections between the layers but not between units within each layer.

FIG. 3B relates to a non-limiting exemplary system 350 with similar or the same components as FIG. 3A, except for the neural network model. In this case, a neural network 362 includes convolutional layers 364, neural network 362, and outputs 312. This particular model is embodied in a CNN (convolutional neural network) 358, which is a different model than that shown in FIG. 3A.

A CNN is a type of neural network that features additional separate convolutional layers for feature extraction, in addition to the neural network layers for classification/identification. Overall, the layers are organized in 3 dimensions: width, height and depth. Further, the neurons in one layer do not connect to all the neurons in the next layer but only to a small region of it. Lastly, the final output will be reduced to a single vector of probability scores, organized along the depth dimension. It is often used for audio and image data analysis, but has recently been also used for natural language processing (NLP; see for example Yin et al, Comparative Study of CNN and RNN for Natural Language Processing, arXiv:1702.01923v1 [cs.CL] 7 Feb. 2017).

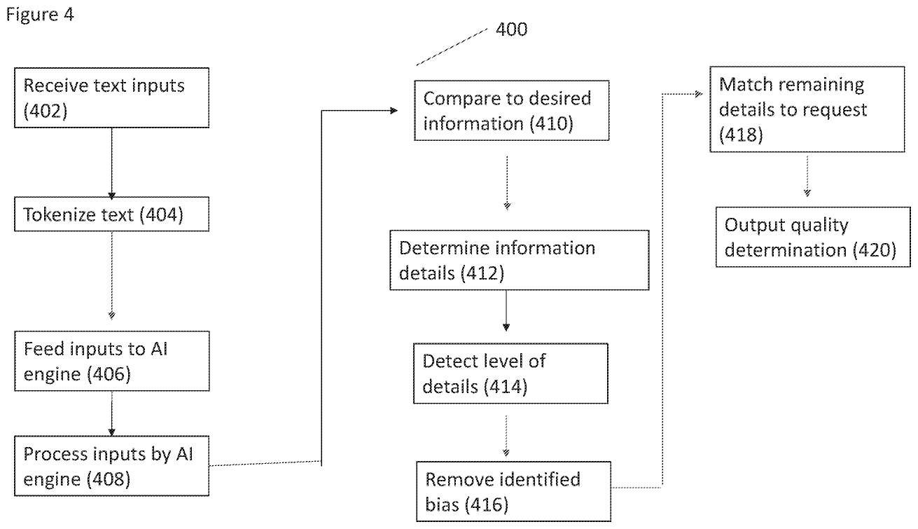

FIG. 4 relates to a non-limiting exemplary flow for analyzing information by an artificial intelligence engine as described herein. As shown with regards to a flow 400, text inputs are received in 402, and are then preferably tokenized in 404, for example, according to the techniques described previously. Next, the inputs are fed to AI engine 406, and the inputs are processed by the AI engine in 408. The information received is compared to the desired information in 410. The desired information preferably includes markers for details that should be included.

In the non-limiting example of crimes for example, the details that should be included preferably relate to such factors as the location of the alleged crime, preferably with regard to a specific address, but at least with enough identifying information to be able to identify where the crime took place, details of the crime such as who committed it, or who is viewed as committing it, if in fact the crime was viewed, and also the aftermath. Was there a broken window? Did it appear that objects had been stolen? Was a car previously present and then perhaps the hubcaps were removed? Preferably the desired information includes any information which makes it clear which crime was committed, when it was committed and where.

In 412 then the information details are analyzed and the level of these details is determinant in 414. Any identified bias is preferably removed in 416. For example with regard to crime tips, this may relate to sensationalized information such as, it was a massive fight, or information that is more emotional than relating to any specific details, such as for example the phrase “a frightening crime”. Other non-limiting examples include the race of the alleged perpetrator as this may this introduce bias into the system. Bias may relate to specific details within a particular report or may relate to a history of a user providing such reports.

In terms of details within a particular report, optionally bias is preset or predetermined during training the AI engine as described in greater detail below. Examples of bias may relate to the use of “sensational” or highly emotional words, as well as markers of a prejudice or bias by the user. Bias may also relate to any overall trends within the report, such as a preponderance of highly emotional or subjective description.

Next, the remaining details are matched to the request in 418 and the output quality is determined in 420. This process is preferably repeated for a plurality of reports received from a plurality of different users, also described as sources herein. The relative quality of such reports may be determined, to rank the reports and also to rank the users.

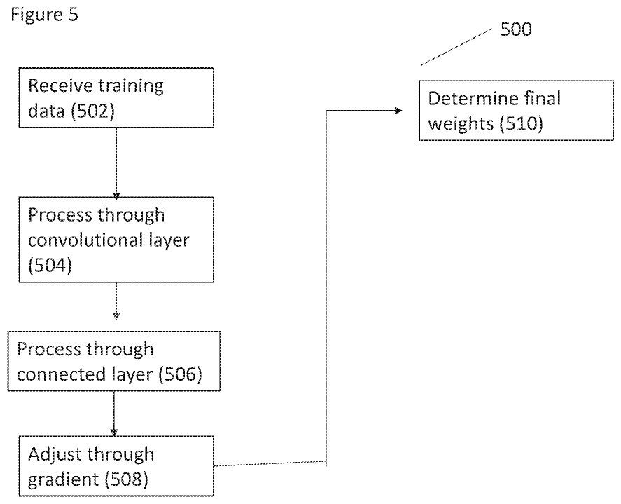

FIG. 5 relates to a non-limiting exemplary flow for training the AI engine. As shown with regard through flow 500, the training data is received in 502 and it is processed through the convolutional layer of the network in 504. This is if a convolutional neural net is used, which is the assumption for this non-limiting example. After that the data is processed through the connected layer in 506 and adjust according to a gradient in 508. Typically, a steep descent gradient is used in which the error is minimized by looking for a gradient. One advantage of this is it helps to avoid local minima where the AI engine may be trained to a certain point but may be in a minimum which is local but it's not the true minimum for that particular engine. The final weights are then determined in 510 after which the model is ready to use.

In terms of provision of the training data, as described in greater detail below, preferably the training data is analyzed to clearly flag examples of bias, in order for the AI engine to be aware of what constitutes bias. During training, optionally the outcomes are analyzed to ensure that bias is properly flagged by the AI engine.

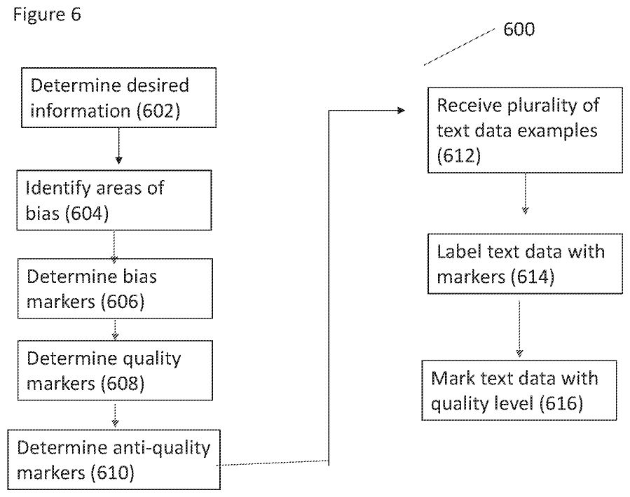

FIG. 6 relates to a non-limiting exemplary method for obtaining training data. As shown with regard to a flow 600, the desired information is determined in 602. For example, for crime tips, again, it's where the alleged crime took place, what the crime was, details of what happened, details about the perpetrator if in fact this person was viewed.

Next in 604, areas of bias are identified. This is important in terms of adjectives which may sensationalize the crimes such as a massive fight as previously described, but also of areas of bias which may relate to race. This is important for the training data because one does not want the AI model to be training on such factors as race but only on factors such as the specific details of the crime.

Next, bias markers are determined in 606. These bias markers are markers which should be flagged and either removed or in some cases actually cause the entire information to be removed. These may include race, these include sensationalist adjectives, and other information which does not further relate to the concreteness of the details being considered.

Next, quality markers are determined in 608. These may include a checklist of information. For example if the crime is burglary, one quality marker might be if any peripheral information is included such as for example whether a broken window is viewed at the property, if the crime took place in a particular property, what was stolen if that is no, other information such as whether or not a burglar alarm went off, the time at which the alleged crime took place, if the person is reporting it after the fact and didn't see the crime taking place, when did they report it, and when did they think the crime took place, and so forth.

Next, the anti-quality markers are determined in 610. These are markers which detract from report. Sensationalist information for example can be stripped out, but it may also be used to detract from the quality of the report as would the race of the person if this is shown to include bias within the report. Other anti-quality markers could for example include details which could prejudice either an engine or a person viewing the information or the report towards a particular conclusion such as, “I believe so and so did this.” This could also be a quality marker, but it can also be an anti-quality marker, and how such information is handled depends also on how the people who are training the AI view the importance of this information.

Next, the plurality of text data examples are received in 612, and then this text data is labeled with markers in 614, assuming it does not come already labeled. Then the text data is marked with the quality level in 616.

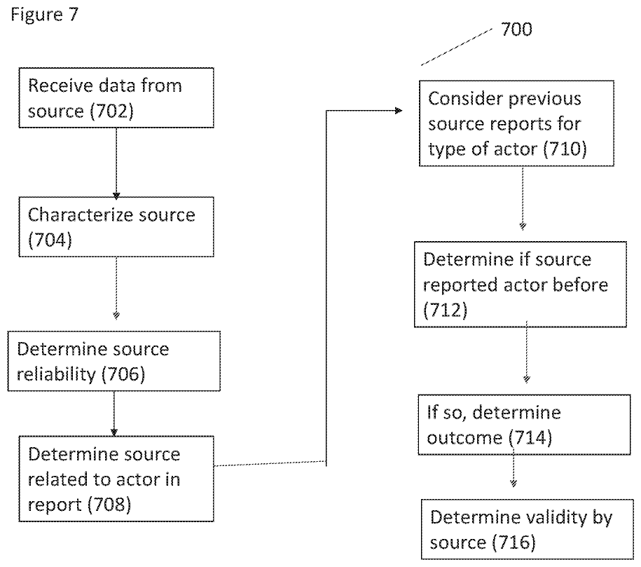

FIG. 7 relates to a non-limiting exemplary method for evaluating a source for data. As shown in the flow 700, data is received from a source 702, which for example could be a particular user identified as previously described. The source is then characterized in 704. Characterization could include such information as the previous reliability of reports of the source, previous information given by the source, whether or not this is the first report, whether or not the report source has shown familiarity with the subject matter. For example, if a source is reporting a crime in a particular neighborhood, some questions that may be considered are whether the source reported that they previously or currently live in the neighborhood, regularly visit the neighborhood, were in the neighborhood for a meeting or running. Any such information may help characterize how and why the source might have come across this information, and therefore why they should be trusted.

In other cases such as for example a matter which relates to subject matter expertise, for example for a particular type of request for biological information, what could be considered here would be the source's expertise. For example, if the source is a person, questions of expertise would relate to whether the source has an educational background in this area, are currently working in a lab, or previously worked in a laboratory in this area and so forth.

Next, the source's reliability is determined in 706 from the characterization factors but also from previous reports given by the source, for example according to the below described reputation level for the source. Next is determined whether the source is related to an actor in the report in 708. In the case of crime, this is particularly important. On the one hand, in some cases, if the source knows the actor, this could be advantageous. For example, if a source is reporting a burglary and they know the person who did it, and they saw the person with the stolen merchandise, this is clearly a factor in favor of the source's reliability. On the other hand, in other cases it might also be indication of a grudge, if the source is trying to implicate a particular person in a crime, this may be an indication that the source has a grudge against the person and therefore reduce their reliability. Whether the source is related to the actor is important, but may not be dispositive as for the reliability of the report.

Next, in 710 the process considers previous source reports for this type of actor. This may be important in cases where a source repeatedly identifies actors by race, there may therefore be bias in this case, indicating that the person has a bias against a particular race. Another issue is also whether the source has reported this particular type of actor before in the sense of bias against juveniles, or bias against people who tend to hang out at a particular park or other location.

Next, in 712 it is determined whether the source has reported the actor before. Again, as in 708, this is a double-edge sword. If it indicates familiarity with the actor, it may be a good thing or it may indicate that the source has a grudge against the actor.

In 714, the outcome is determined according to all of these factors such as the relationship between the source and the actor, whether or not the source has given previous reports for this type of actor or for this specific actor. Then the validity is determined by source in 716 which may also include such factors as source characterization and source reliability.

The above process is preferably repeated for a plurality of sources. The greater the number of sources contributing reports and information, the more accurate the process becomes, in terms of determining the overall validity of the provided report.

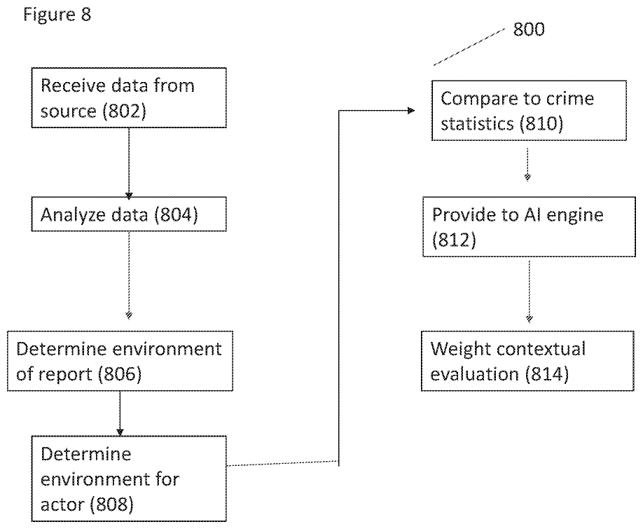

FIG. 8 relates to a non-limiting exemplary method for performing context evaluation for data. As shown in the flow 800, data is received from a source, 802, and is analyzed in 804. Next, the environment of the report is determined in 806. For example, for a crime, this could relate to the type of crime reported in a particular area. If a pickpocket event is reported in an area which is known to be frequented by pickpockets and have a lot of pick pocketing crime, this would tend to increase the validity of the report. On the other hand, if a report of a crime indicates that a TV was stolen from a store but there are no stores selling TVs in that particular area, then that would reduce the validity of the report given that the environment does not have any stores that would sell the object that was apparently stolen.

In 808 the environment for the actor is determined. Again, this relates to whether or not the actor is likely to have been in a particular area at a particular time. If a particular actor is named and that actor lives on a different continent and was not actually visiting the continent or country in question at the time, this would clearly reduce the validity of the report. Also, if one is discussing a crime by a juvenile and this is during school hours, it would also then actually determine whether or not the juvenile actually had attended school. If the juvenile had been in school all day, then this would again count against the environmental analysis.

In 810 the information is compared to crime statistics, again, to determine likelihood of crime, and all this information is provided to the AI engine in 812. In 814 the contextual evaluation is then weighted. These are all the different contexts for the data and the AI engine determines whether or not based on these contexts the event was more or less likely to have occurred as reported and also the relevance and reliability of the report.

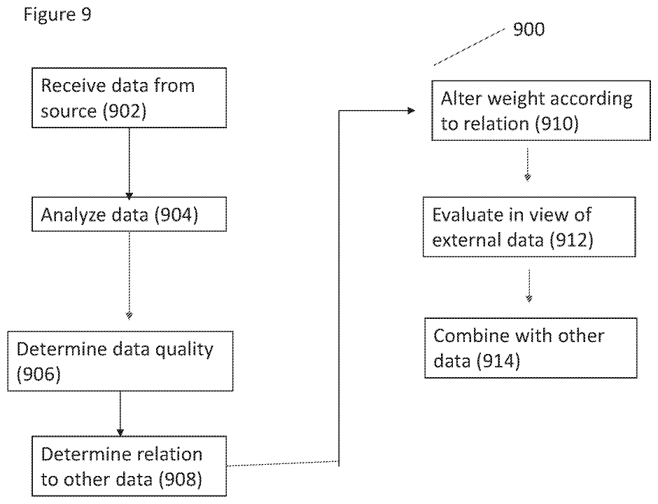

FIG. 9 relates to a non-limiting exemplary method for connection evaluation for data. The connections that are evaluated preferably relate to connections or relationships between various sets or types of data, or data components. As shown in the flow 900, data is received from the source 902 and analyzed in 904. Optionally such analysis includes decomposing the data into a plurality of components, and/or characterizing the data according to one or more quality markers. A non-limiting example of a component is for example a graph, a number or set of numbers, or a specific fact. With regard to the example of a crime tip or report, the specific fact may relate to a location of a crime, a time of occurrence of the crime, the nature of the crime and so forth.

The data quality is then determined in 906, for example according to one or more quality markers determined in 904. Optionally data quality is determined per component. Next, the relationship between this data and other data is determined in 908. For example, the relationship could be multiple reports for the same crime. If there are multiple reports for the same crime, the importance would be then connecting these reports and showing whether or not the data in the news report substantiates the data in previous report, contradicts the data in previous reports, and also whether or not multiple reports solidify each other's data or contradict each other's data.

This is important because if there are multiple conflicting reports, if it is not clear what crime exactly occurred, or details of the crime such when and how or what happened, or if something was stolen, what was stolen, then this would indicate that the multiple reports are less reliable because reports should preferably reinforce each other.

The relationship may also be determined for each component of the data separately, or for a plurality of such components in combination.

In 910 the weight is altered according to the relationship between the received data and previously known data, and then all of the data is preferably combined in 912. Optionally data from a plurality of different sources and/or reports may be combined. One non-limiting example of a method for combining such data is related to risk terrain mapping. In the context of data related to crime tips, such risk terrain mapping may relate to combining data and/or reports to find “hot spots” on a map. Such a map may then be analyzed in terms of the geography and/or terrain of the area (city, neighborhood, area, etc.) to theorize why that particular category of crime report occurs more frequently than others. For example, effects of terrain in a city crime context may relate to housing types and occupancy, business types, traffic, weather, lighting, environmental design, and the like, which could affect the patterns of crime occurring in that area. Such an analysis may assist in preventing or reducing crimes in a particular category.

In terms of non-crime data, the risk terrain mapping or modeling may involve actual geography, for example for acute or chronic diseases, or for any other type of geographically distributed data or effects. However such mapping may also occur across a virtual geography for other types of data.

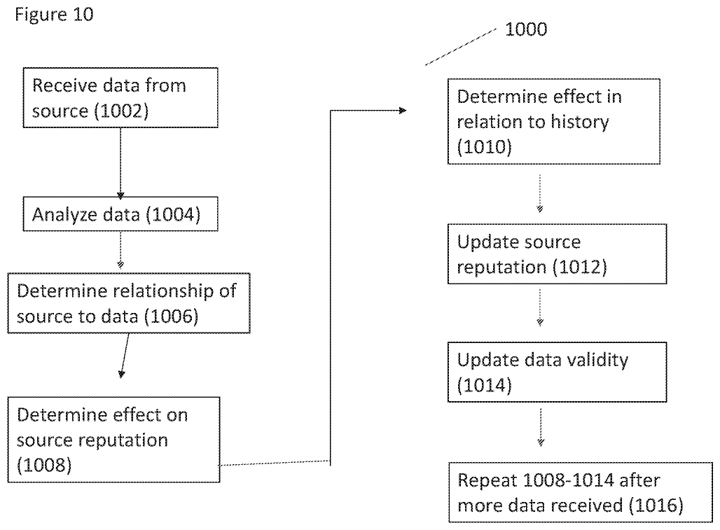

FIG. 10 relates to a non-limiting exemplary method for source reliability evaluation. In this context, the term “source” may for example relate to a user as described herein (such as the user of FIG. 1) or to a plurality of users, including without limitation an organization. A method 1000 begins by receiving data from a source 1002. The data is identified as being received from the source, which is preferably identifiable at least with a pseudonym, such that it is possible to track data received from the source according to a history of receipt of such data.

Next the data is analyzed in 1004. Such analysis may include but is not limited to decomposing the data into a plurality of components, determining data quality, analyzing the content of the data, analyzing metadata and a combination thereof. Other types of analysis as described herein may be performed, additionally or alternatively.

In 1006, a relationship between the source and the data is determined. For example, the source may be providing the data as an eyewitness account. Such a direct account is preferably given greater weight than a hearsay account. Another type of relationship may involve the potential for a motive involving personal gain, or gain of a related third party, through providing the data. In case of a reward or payment being offered for providing the data, the act of providing the data itself would not necessarily be considered to indicate a desire for personal gain. For scientific data, the relationship may for example be that of a scientist performing an experiment and reporting the results as data. The relationship may increase the weight of the data, for example in terms of determining data quality, or may decrease the weight of the data, for example if the relationship is determined to include a motive related to personal gain or gain of a third party.

In 1008, the effect of the data on the reputation of the source is determined, preferably from a combination of the data analysis and the determined relationship. For example, high quality data and/or data provided by a source that has been determined to have a relationship that involves personal gain and/or gain for a third party may increase the reputation of the source. Low quality data and/or data provided by a source that has been determined to have a relationship involving such gain may decrease the reputation of the source. Optionally the reputation of the source is determined according to a reputation score, which may comprise a single number or a plurality of numbers. Optionally, the reputation score and/or other characteristics are used to place the source into one of a plurality of buckets, indicating the trustworthiness of the source—and hence also of data provided by that source.

The effect of the data on the reputation of the source is also preferably determined with regard to a history of data provided by the source in 1010. Optionally the two effects are combined, such that the reputation of the source is updated for each receipt of data from the source. Also optionally, time is considered as a factor. For example, as the history of receipts of data from the source evolves over a longer period of time, the reputation of the source may be increased also according to the length of time for such history. For example, for two sources which have both made the same number of data provisions, a greater weight may be given to the source for which such data provisions were made over a longer period of time.

In 1012, the reputation of the source is updated, preferably according to the calculations in both 1008 and 1010, which may be combined according to a weighting scheme and also according to the above described length of elapsed time for the history of data provisions.

In 1014, the validity of the data is optionally updated according to the updated source reputation determination. For example, data from a source with a higher determined reputation is optionally given a higher weight as having greater validity.

Optionally, 1008-1014 are repeated at least once, after more data is received, in 1016. The process may be repeated continuously as more data is received. Optionally the process is performed periodically, according to time, rather than according to receipt of data. Optionally a combination of elapsed time between performing the process and data receipt is used to trigger the process.

Optionally reputation is a factor in determining the speed of remuneration of the source, for example. A source with a higher reputation rating may receive remuneration more quickly. Different reputation levels may be used, with a source progressing through each level as the source provides consistently valid and/or high quality data over time. Time may be a component for determining a reputation level, in that the source may be required to provide multiple data inputs over a period of time to receive a higher reputation level. Different reputation levels may provide different rewards, such as higher and/or faster remuneration for example.

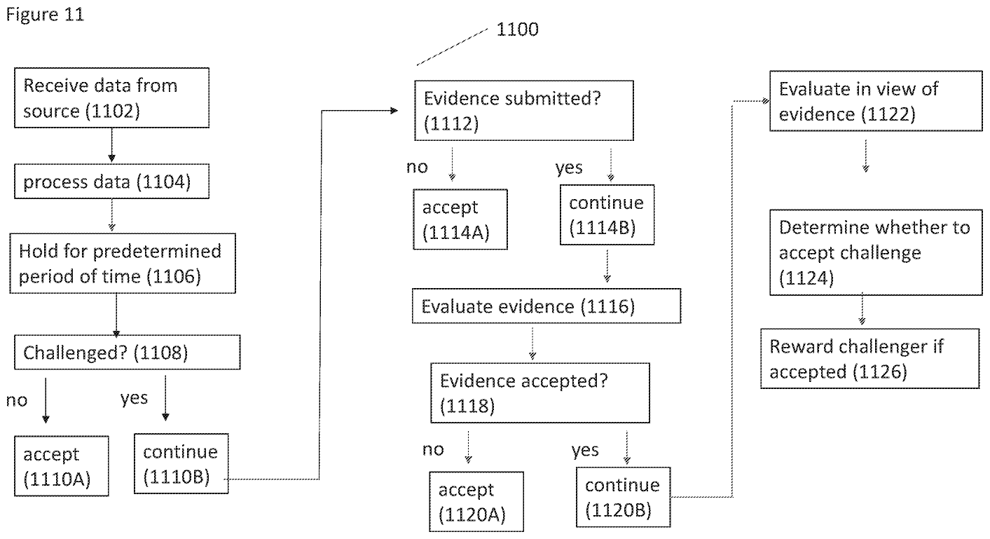

FIG. 11 relates to a non-limiting exemplary method for a data challenge process. The data challenge process may be used to challenge the validity of data that is provided, in whole or in part. A process 1100 begins with receiving data from a source in 1102, for example as previously described. In 1104, the data is processed, for example to analyze it and/or associated metadata, for example as described herein. A hold is then placed on further processing, analysis and/or use of the data in 1106, to allow time for the data to be challenged. For example, the data may be made available to one or more trusted users and/or sources, and/or to external third parties, for review. A reviewer may then challenge the validity of the data during this holding period.

If the validity of the data is not challenged in 1108, then the data is accepted in 1110A, for example for further analysis, processing and/or use. The speed with which the data is accepted, even if not challenged, may vary according to a reputation level of the source. For example, for sources with a lower reputation level, a longer period of time may elapse before the data is accepted. For sources with a lower reputation level, there may be a longer period of time during which challenges may be made. By contrary, for sources with a higher reputation level, such a period of time for challenges may be shorter. As a non-limiting example, for sources with a lower reputation level, the period of time for challenges may be up to 12 hours, up to 24 hours, up to 48 hours, up to 168 hours, up to two weeks or any time period in between. For sources with a higher reputation level, such a period of time may be shortened, by 25%, 50%, 75% or any other percentage amount in between.

If the validity of the data is challenged in 1108, then a challenge process is initiated in 1110B. The challenger is invited to provide evidence to support the challenge in 1112. If the challenger does not submit evidence, then the data is accepted as previously described in 1114A. If evidence is submitted, then the challenge process continues in 1114B.

The evidence is preferably evaluated in 1116, for example for quality of the evidence, the reputation of the evidence provider, the relationship between the evidence provider and the evidence, and so forth. Optionally and preferably the same or similar tools and processes are used to evaluate the evidence as described herein for evaluating the data and/or the reputation of the data provider. The evaluation information is then preferably passed to an acceptance process in 1118, to determine whether the evidence is acceptable. If the evidence is not acceptable, then the data is accepted as previously described in 1120A.

If the evidence is acceptable, then the challenge process continues in 1120B. The challenged data is evaluated in light of the evidence in 1122. If only one or a plurality of data components were challenged, then preferably only these components are evaluated in light of the provided evidence. Optionally and preferably, the reputation of the data provider and/or of the evidence provider are included in the evaluation process.

In 1124, it is determined whether to accept the challenge, in whole or in part. If the challenge is accepted, in whole or optionally in part, the challenger is preferably rewarded in 1126. The data may be accepted, in whole or in part, according to the outcome of the challenge. If accepted, then its weighting or other validity score may be adjusted according to the outcome of the challenge. Optionally and preferably, the reputation of the challenger and/or of the data provider is adjusted according to the outcome of the challenge.

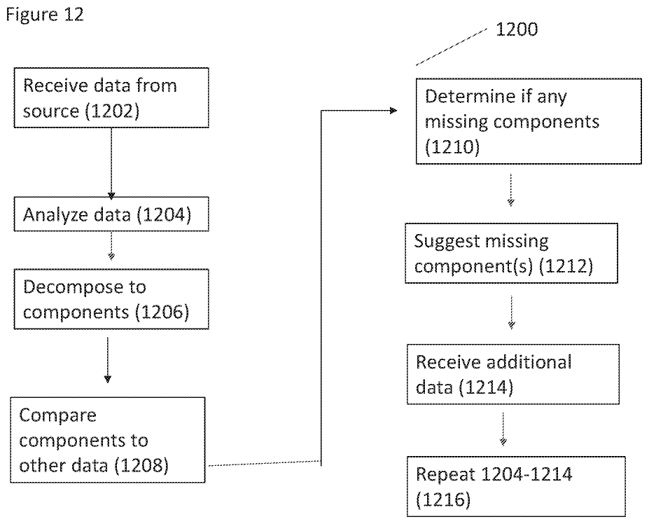

FIG. 12 relates to a non-limiting exemplary method for a reporting assistance process. This process may be performed for example through the previously described user app, such that when a user (or optionally a source of any type) reports data, assistance is provided to help the user provide more complete or accurate data. A process 1200 begins with receiving data from a source, such as a user, in 1202. The data may be provided through the previously described user app or through another interface. The subsequent steps described herein may be performed synchronously or asynchronously. The data is then analyzed in 1204, again optionally as previously described. In 1206, the data is preferably broken down into a plurality of components, for example through natural language processing as previously described.

The data components are then preferably compared to other data in 1208. For example, the components may be compared to parameters for data that has been requested. For the non-limiting example of a crime tip or report, such parameters may relate to a location of the crime, time and date that the crime occurred, nature of the crime, which individual(s) were involved and so forth. Preferably such a comparison is performed through natural language processing.

As a result of the comparison, it is determined whether any data components are missing in 1210. Again for the non-limiting example of a crime tip or report, if the data components do not include the location of the crime, then the location of the crime is determined to be a missing data component. For each missing component, optionally and preferably a suggestion is made as to the nature of the missing component in 1212. Such a suggestion may include a prompt to the user making the report, for example through the previously described user app. As a result of the prompts, additional data is received in 1214. The process of 1204-1214 may then be repeated more than once in 1216, for example until the user indicates that all missing data has been provided and/or that the user does not have all answers for the missing data.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A system for analyzing input crowdsourced information, comprising a plurality of user computational devices, each user computational device comprising a user app; a server, comprising a server interface and an AI (artificial intelligence) engine; and a computer network for connecting said user computational devices and said server; wherein crowdsourced information is provided through each user app and is analyzed by said AI engine, wherein said AI engine determines a quality of said information received through each user app, wherein said quality of information comprises at least a level of detail and a determination of bias.

2. The system of claim 1, wherein said server comprises a server processor and a server memory, wherein said server memory stores a defined native instruction set of codes; wherein said server processor is configured to perform a defined set of basic operations in response to receiving a corresponding basic instruction selected from said defined native instruction set of codes; wherein said server comprises a first set of machine codes selected from the native instruction set for receiving crowdsourced information from said user computational devices, and a second set of machine codes selected from the native instruction set for executing functions of said AI engine.

3. The system of claim 2, wherein each user computational device comprises a user processor and a user memory, wherein said user memory stores a defined native instruction set of codes; wherein said user processor is configured to perform a defined set of basic operations in response to receiving a corresponding basic instruction selected from said defined native instruction set of codes; wherein said user computational device comprises a first set of machine codes selected from the native instruction set for receiving information through said user app and a second set of machine codes selected from the native instruction set for transmitting said information to said server as said crowdsourced information.

4. The system of claim 1, wherein said AI engine determines bias according to one or more of an indication of bias against a particular feature, group or person, or a presence of an emotional word in said information.

5. The system of claim 1, wherein said AI engine determines said bias according to an identity of said user app providing said information, wherein said identity is of a source of said information.

6. The system of claim 5, wherein said AI engine further considers a history of contributions by a particular source to determine a level of quality of said information.

7. The system of claim 5, wherein said information includes a determination of an action by an actor, and said AI engine further considers a relationship between said actor and said source to determine said quality.

8. The system of claim 7, wherein said information includes a determination of an environment from which said information is derived, and said AI engine further considers a context of said information according to said environment.

9. The system of claim 8, wherein said AI engine further weights a quality of said information according to said context.

10. The system of claim 1, wherein said AI engine comprises deep learning and/or machine learning algorithms.

11. The system of claim 10, wherein said AI engine comprises an algorithm selected from the group consisting of word2vec, a DBN, a CNN and an RNN.

12. The system of claim 1, wherein said crowdsourced information is received in a form of a document, further comprising a tokenizer for tokenizing the document into a plurality of tokens, and a machine learning algorithm for analyzing said tokens to determine a quality of information contained in said document.

13. The system of claim 12, wherein said AI engine compares said tokens to desired information, to determine said quality of information.

14. The system of claim 1, wherein each user app is associated with a unique user identifier and wherein said AI engine further determines quality of information received through said user app according to said unique user identifier, including with regard to information previously received according to said unique user identifier.

15. The system of claim 14, wherein said user computational device comprises a mobile communication device and wherein said unique user identifier identifies said mobile communication device.

16. The system of claim 1, wherein said crowdsourced information comprises crime tips.

17. The system of claim 1, wherein said AI engine further considers information from a plurality of different user apps, and combines said information according to a quality rating of information from each user app.

18. A method for training an AI engine in a system according to claim 1, the method comprising receiving a plurality of data examples, wherein said data examples are tokenized; determining quality and anti-quality markers for said tokens of said data examples; and training said AI engine according to said tokens labeled with said quality markers and said anti-quality markers.

19. A method for analyzing input crowdsourced information, comprising operating a system according to claim 1, further comprising tokenizing input information, analyzing said tokenized information by said AI engine and determining a level of quality by said AI engine.

20. The method of claim 19, further comprising receiving a plurality of reports from a plurality of different sources, each report comprising information; and combining said information from said different sources according to a quality of said source, a quality of said information or a combination of said qualities.

21. The method of claim 20, further comprising receiving a challenge to information in a report by a different data source and/or user app; determining whether said challenge is valid; and accepting or rejecting said information in said report according to a validity of said challenge by said AI engine.
